(19) United States
(12) Patent Application Publication
(10) Pub. No.: US 2024/0264741 A1
(43) Pub. Date: Aug. 8, 2024

(54) DYNAMIC GENERATION OF INTERACTIVE COMPONENTS FOR ON-DEMAND INTERACTIVE SESSIONS DURING VIRTUAL CONFERENCES

(71) Applicant: Adobe Inc., San Jose, CA (US)

(72) Inventors: Naveen Prakash Goel, Noida (IN); Ramesh Srinivasaraghavan, Bangalore (IN); Gokul Krishna Paravasthu, Bangalore (IN)

(21) Appl. No.: 18/105,328

(22) Filed: Feb. 3, 2023

(51) Int. Cl. G06F 3/0489; G06F 3/0482; H04L 65/403

(52) U.S. Cl. CPC G06F 3/0489; G06F 3/0482; H04L 65/403

(57) ABSTRACT

In some examples, a virtual conferencing platform establishes a virtual conference among a host client and multiple devices. During the virtual conference, the virtual conferencing platform receives a start-triggering signal from the host device to start an interactive session and generates an interactive component for the interactive session in response to receiving the start-triggering signal. The interactive component comprises a UI element presenting a combination of interaction options, and multiple responses. The virtual conferencing platform causes the UI element presenting the combination of interaction options to be displayed in respective participant UIs of the virtual conference on the multiple devices and receives the multiple responses from the multiple devices. The virtual conferencing platform then receives an end-triggering signal and deactivates the interactive component in the respective UIs of the virtual conference on the multiple devices in response to receiving the end-triggering signal.

### TECHNICAL FIELD

This disclosure relates generally to virtual conferencing. More specifically, but not by way of limitation, this disclosure relates to dynamically generating an interactive component to enable an interactive session on demand during a virtual conference.

### BACKGROUND

Videoconferencing has become a common way for people to meet as a group without being at the same physical location. The advent of user-friendly videoconferencing software has enabled users to create and join a videoconference meeting via various types of devices, such as personal computers or smart phones. After joining a meeting, participants receive audio and/or video streams or feeds from other participants. The participants can see and/or hear each other, engage with each other, and generally have a richer experience despite not being physically in the same space. For example, a meeting host can create an interactive component for an interactive session, such as a poll, to collect responses from participants to gain insights about a certain interactive topic. The interactive component is usually generated manually before the meeting starts. If the meeting host decides to generate an interactive component during the meeting, the meeting host has to manually create or ask a co-host or a co-presenter to manually create the interactive component. This will inevitably cause delay in the meeting and interrupt the meeting flow.

### SUMMARY

Certain embodiments involve dynamically generating an interactive component to enable an interactive session on demand during a virtual conference. In one example, a computing system establishes a virtual conference among a host device and multiple participant devices. During the virtual conference, the computing system receives a start-triggering signal from the host device to start an interactive session and generates an interactive component for the interactive session of the virtual conference. The start-triggering signal is associated with a combination of interaction options. The interactive component comprises a user interface (UI) element presenting the combination of interaction options. The computing system causes the UI element presenting the combination of interaction options to be displayed in respective participant UIs of the virtual conference on the multiple participant devices and receives multiple responses from the multiple participant devices. Upon receiving an end-triggering signal for ending the interactive session from the host device, the computing system deactivates the interactive component in the respective UIs of the virtual conference on the multiple participant devices.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 depicts an example of a computing environment in which a virtual conferencing platform generates an interactive component during a virtual conference, according to certain embodiments of the present disclosure.

FIG. 2 depicts an example of a process for generating an interactive component during a virtual conference, according to certain embodiments of the present disclosure.

FIG. 3 depicts an example of a process for replaying the interactive session after the virtual conference is ended, according to certain embodiments of the present disclosure.

FIG. 4 depicts a mapping between start keys and possible answers to corresponding sample poll questions, according to certain embodiments of the present disclosure.

FIG. 5 depicts an example of a floating window presenting a poll question and a group of possible answers, according to certain embodiments of the present disclosure.

FIG. 6 depicts an example workflow of creating a poll pod during a virtual conference, according to certain embodiments of the present disclosure.

FIG. 7 depicts an example workflow of creating a report for a poll session after a virtual conference, according to certain embodiments of the present disclosure.

FIG. 8 depicts an example of a computing system for implementing certain embodiments of the present disclosure.

### DETAILED DESCRIPTION

Certain embodiments involve dynamically generating an interactive component to enable an interactive session on demand during a virtual conference. For instance, a virtual conferencing platform establishes a virtual conference among a host device and multiple participant devices. During the virtual conference, the virtual conferencing platform receives a start-triggering signal from the host device to start an interactive session and generates an interactive component for the interactive session in response to receiving the start-triggering signal. The interactive component includes a user interface (UI) element presenting a combination of interaction options. The UI element presenting the combination of interaction options can be displayed in respective participant UIs of the virtual conference on the multiple participant devices. The UI element may also present an interaction topic extracted from an audio signal captured around the time the start-triggering signal is received. The interactive component can receive multiple responses from the multiple participant devices. The virtual conferencing platform may subsequently receive an end-triggering signal from the host device and deactivates the interactive component in the respective participant UIs on the multiple participant devices.

The following non-limiting example is provided to introduce certain embodiments. In this example, a host device and multiple participant devices communicate with a virtual conferencing platform over a network. The host device and the multiple participant devices are installed with a client application provided by the virtual conferencing platform. The virtual conferencing platform establishes a virtual conference among the host device and the multiple participant devices. The virtual conference can be a webinar, a virtual townhall, a virtual classroom, or any other virtual collaboration scenarios.

During the virtual conference, the virtual conferencing platform receives a start-triggering signal from the host device to start an interactive session. In response to receiving the start-triggering signal, an interactive component generation module of the virtual conferencing platform generates an interactive component for the interactive session. The interactive session can involve an interaction topic, a combination of interaction options, and multiple responses. The interactive component includes a UI element configured to present the combination of interaction options. The UI element may also be configured to present the interaction topic. The interactive component generation module can transmit the UI element to participant UIs of the virtual conference on multiple participant devices for interaction. The interactive component can receive the multiple responses from multiple participant devices. In some examples, the interactive session is a poll session, the interactive component is a poll pod, the interaction topic is a poll question, the combination of interaction options is a combination of answer options, and the multiple responses are participant answers to the poll question from the multiple participant devices based on the combination of answer options.

The start-triggering signal can be generated based on one or more keys being pressed down. The one or more keys are preset to be associated with the combination of interaction options. Alternatively, or additionally, the start-triggering signal can be generated based on a visual element (e.g., a button on a tool bar) in the host UI of the virtual conference on the host device being activated. The visual element is preset to be associated with the combination of interaction options. The virtual conferencing platform can provide multiple combinations of interaction options pre-programmed to be associated with respective start-triggering components, such as keys or visual elements. The multiple combinations of the interaction options can be displayed in the host UI of the virtual conference on the host device.

Since the start-triggering components such as keys or visual elements are associated with respective combinations of interaction components, the interactive component generation module receives a combination of interaction options selected by the host device when a corresponding start-triggering component is being activated. The combination of interaction options can be sent in an editable format to the host UI of the virtual conference on the host device. The host device can edit the combination of interaction options before the interactive component generation module generates a UI element presenting the combination of the interaction topics.

Once the combination of interaction options is approved at the host device, the interactive component generation module then generates an interactive component including a UI element presenting the combination of interaction options and sends the interactive component to the multiple participant devices so that the UI element can be presented in the respective participant UIs of the virtual conference for interaction. Optionally, the UI element can also present the interaction topic to the multiple participant devices. The interaction topic can be extracted from an audio signal from the host device using speech recognition technology. The interactive component may receive responses to the interaction topic from multiple participant devices via the UI element of the interactive component displayed on the multiple participant devices. The responses can be stored on the virtual conferencing platform for analysis. The interactive component can also broadcast a distribution or an aggregated response of the multiple responses to the multiple participant devices.

The interactive component generation module then receives an end-triggering signal for ending the interactive session from the host device. Similar to the start-triggering signal, the end-triggering signal can be generated based on a hotkey being pressed. The hotkey is preset to be associated with ending the interactive session. Alternatively, or additionally, the end-triggering signal can be generated based on a graphic element (e.g., a button on a tool bar) in the host UI of the virtual conference on the host device being activated. The graphic element is preset to be associated with ending the interactive session. The interactive component generation module then deactivates the UI element presenting the combination of interaction optics on the multiple participant devices in response to receiving the end-triggering signal.

Certain embodiments of the present disclosure overcome the disadvantages of the prior art, by dynamically creating an interactive component using preset interaction options during a virtual conference. The proposed process enables on-demand interactive sessions during a virtual conference without interrupting the flow of the live virtual conference and without a priori setup of the interactive session. Various combinations of interaction options are preset to be associated with a hotkey combination, or a visual element in a host UI of the virtual conference. An interactive component can be generated automatically when the hotkey combination is being pressed or the visual element is being activated. The associated combination of interaction options can be displayed automatically in the UI of the virtual conference without manual typing. Thus, the time for generating an interactive component during the virtual conference can be reduced significantly, and the flow of the conference will not be interrupted. Additionally, the interaction topic can be captured via audio during a live interactive session. Speech recognition technology can also be used to convert the audio signal of the interaction topic to a text format for display during the interactive session. Automatically extracting the interaction topic from the audio signal without a user typing out the interaction topic further reduces time for generating the interactive component during the virtual conference.

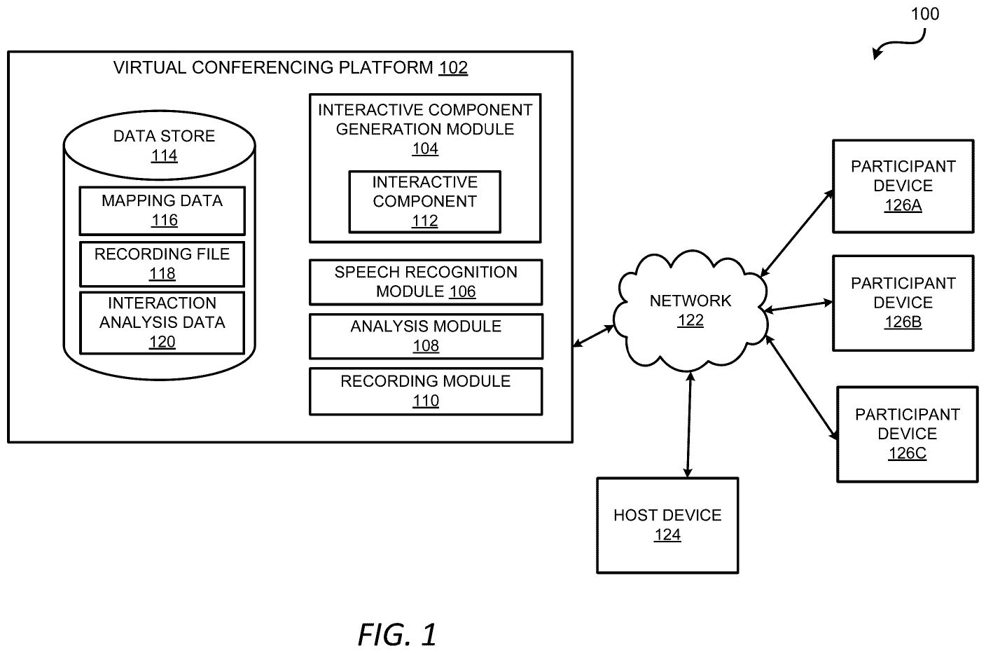

Referring now to the drawings, FIG. 1 depicts an example of a computing environment 100 in which a virtual conferencing platform 102 generates an interactive component 112 during a virtual conference, according to certain embodiments of the present disclosure. In various embodiment, the computing environment 100 includes a virtual conferencing platform 102 connected with a host device 124 and participant devices 126A, 126B, and 126C (which may be referred to herein individually as a participant device 126 or collectively as the participant devices 126) via the network 122. The network 122 may be a local-area network (“LAN”), a wide-area network (“WAN”), the Internet, or any other networking topology known in the art that connects the host device 124 and the participant devices 126 to the virtual conferencing platform 102. The virtual conferencing platform 102 can establish a virtual conference between the host device 124 and the participant devices 126. The virtual conferencing platform 102 is configured to generate an interactive component for an interactive session on demand during the virtual conference for the host device 124 and the multiple participant devices 126.

The virtual conferencing platform 102 includes an interactive component generation module 104, a speech recognition module 106, an analysis module 108, a recording module 110, and a data store 114. The interactive component generation module 104 is configured to generate an interactive component 112 on demand for launching an interactive session for the host device 124 and multiple participant devices 126 during a virtual conference. The host device 124 can interact with the interactive component generation module 104 via a host UI of the virtual conference. An interactive session involves an interaction topic, a combination of interaction options, and multiple responses.

The interactive component generation module 104 is configured to map multiple combinations of interaction options to multiple start-triggering components, such as hotkeys or visual graphic elements on the host UI. The mapping data 116 between start-triggering components and combinations of interaction options is stored in the data store 114. A start-triggering signal is generated when a start-triggering component is activated. Upon receiving the triggering signal from the start-triggering component, the interactive component generation module 104 can build an interactive component 112 including a UI element presenting the combination of interaction options mapped to the activated start-triggering component. The interactive component generation module 104 can send the UI element to the multiple participant devices 126 for display in the participant UIs of the virtual conference. The interactive component generation module 104 can also receive responses from the multiple participant devices via different input devices, such as keyboards, mouse, touchscreen, camera, or microphone.

The interactive component generation module 104 is also configured to deactivate the interactive component 112 by activating an end-triggering component. In some examples, the end-triggering component is a hotkey that is programmed to, when activated, generate a command of ending an interactive session. In some examples, the end-triggering component is created as a visual element on the host UI. When the visual element is activated, a command of ending an interactive session is generated and the interactive component 112 is deactivated.

The virtual conferencing platform 102 also includes a speech recognition module 106 to convert an audio signal from the host device 124 to a text message during the interactive session of the virtual conference. To do so, the speech recognition module 106 can implement a closed caption algorithm or a speech-to-text algorithm. The virtual conferencing platform 102 also includes an analysis module 108, which can implement a natural language processing algorithm, to determine the interaction topic for the interactive session from the text message during the interactive session of the virtual conference. In some examples, when the start-triggering signal is received by the interaction component generation module 104, the speech recognition module 106 inserts a start-timestamp in the audio signal stream from the host device 124. The start timestamp can also be inserted into the audio signal by the client application of the virtual conferencing platform 102 on the host device 124, before the audio signal is transmitted to the virtual conferencing platform 102. The interaction topic is usually mentioned in the audio signal around the start timestamp. For example, the text message for the audio signal from one minute before the start timestamp to one minute after the start timestamp can be analyzed to identify the interaction topic. In some examples, a host can be instructed to press a hotkey or activate a visual element when the host is about to utter the interaction topic and press the same hotkey or activate the same visual element again when the host finishes giving the interaction topic. Thus, when the host presses a hotkey or activates a visual element to generate a start-triggering signal, the speech recognition module 106 can insert a first timestamp in the audio signal stream from the host device 124; when the host presses the same hotkey or activates same visual element within a period of time, for example 1 or 2 minutes, the speech recognition module 106 can insert a second timestamp. Alternatively, the first and second timestamps can be inserted in the audio signal before the audio signal is transmitted to the virtual conferencing platform 102. The analysis module 108 can then extract the interaction topic from the text message between the first timestamp and the second timestamp.

The interactive component generation module 104 can include the interaction topic in the UI element with the combination of interaction options, when the UI element is displayed in the respective participant UIs of the virtual conference on the multiple participant devices 126 during the interactive session. In addition, the analysis module 108 can also process the responses from the multiple participant devices 126 during the interactive session to generate a dynamic distribution of the responses or an aggregated response. In some examples, the interactive component generation module 104 can present the dynamic distribution or the aggregated response in the participant UIs on the multiple participant devices 126 during the interactive session. The multiple responses and the distribution or the aggregated response can be stored as part of the interaction data 120 in the data store 114. In addition, the analysis module 108 can analyze the interaction topic and the responses to generate analysis data, store the analysis data as part of the interaction data 120 in the data store 114, and generate a report to the host device 124 after the interactive session is ended. The report can be sent to the host device 124 after the interactive session is ended while the virtual conference is still undergoing or after the virtual conference is ended.

The virtual conferencing platform 102 also includes a recording module 110 to record the virtual conference. A recording file 118 can be created and stored in the data store 114. The recording file 118 can include audio data for the virtual conference and interaction-related data for the interactive session. In some examples, the recording file 118 also include video data for the virtual conference. During the virtual conference, when the virtual conferencing platform 102 receives a start-triggering signal, the recording module 110 can insert a start timestamp for receipt of the start-triggering signal in the recording file 118. When the virtual conferencing platform 102 receives an end-triggering signal, the recording module 110 can insert an end timestamp for receipt of the end-triggering signal in the recording file 118. The interaction-related data in the recording file includes the combination of interaction options, the responses received from participant devices, the start timestamp, and the end timestamp. Alternatively, or additionally, the interaction-related data stored in the recording file 118, such as the interaction topic and the responses, can also be stored as interaction data 120 for the interactive session in the data store 114.

In some examples, the recording file 118 can be replayed on a new participant device after the virtual conference is ended, such as a device associated with a user who missed the live conference and tries to catch up by reviewing the replay of the recording file 118. The interactive component 112 can be activated during the replay and the UI element presenting the combination of interaction options for the interactive session can be displayed on the new participant device for interaction with the new participant device. The recording module 110 can receive and record a response from the new participant device. The recording file 118 can be updated to include the response in the interaction-related data.

The analysis module 108 can extract and convert a segment of audio data around the start timestamp from the recording file 118 to text after the virtual conference is ended. The analysis module 108 can determine the interaction topic of the interaction session by analyzing the text. The analysis module 108 can analyze the interaction-related data in the recording file 118, such as the interaction topic and the multiple responses, to generate analysis data. The analysis data can be stored as part of the interaction data 120 in the data store 114. The analysis module 108 can generate a report using the analysis data and send the report to the host device 124.

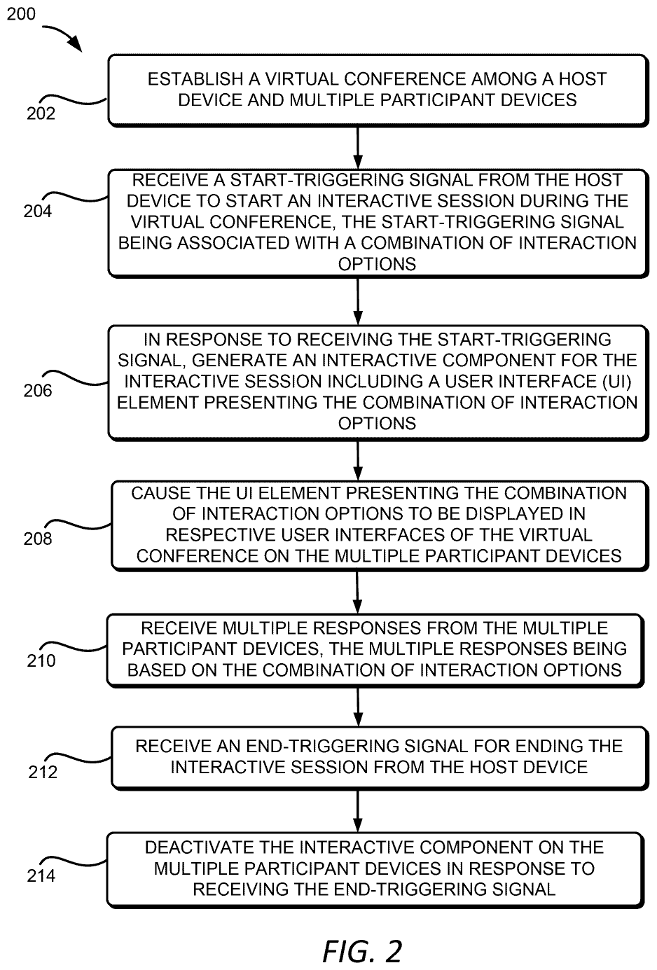

FIG. 2 depicts an example of a process 200 for generating an interactive component 112 during a virtual conference, according to certain embodiments of the present disclosure. At block 202, a virtual conferencing platform 102 establishes a virtual conference among a host device 124 and multiple participant devices 126. The virtual conference may be a hybrid virtual conference, including participants on-site with the host. In a pure virtual conference, all participants join the virtual conference via participant devices. A client-side application may be installed on the host device 124 and the multiple participant devices 126. The host device 124 may initiate the virtual conference via the installed client-side application. The client-side application may be the same on both the host device 124 and the multiple participant devices 126. However, the host UI of the virtual conference on the host device 124 may have additional features than that on the multiple participant devices 126. For example, the host UI may include a button for recording the virtual conference. As another example, the host UI may include elements (e.g., start-triggering buttons and a mapping between start-triggering buttons and combinations of interaction options) for generating an interactive component for launching an interactive session (e.g., a poll session).

At block 204, the virtual conferencing platform 102 receives a start-triggering signal from the host device 124 to start an interactive session during the virtual conference. An interactive session can involve or be associated with an interaction topic, a combination of interaction options, and multiple responses. The start-triggering signal is associated with a combination of interaction options. The virtual conferencing platform 102 stores mapping data 116 between multiple start-triggering components and multiple combinations of interaction options in a data store 114. In some examples, the start-triggering components are keys on the keyboard preset to be associated with combinations of interaction options. When one key or a combination of keys on the host device are being pressed, a start-triggering signal is generated and transmitted to the virtual conferencing platform 102 for starting an interactive session with a corresponding combination of interaction options. In some examples, the start-triggering components are visual elements in a host UI of the virtual conference on the host device 124. The host UI may be configured to present combinations of interaction options associated with corresponding visual elements. The visual elements can be buttons or checkboxes. When a visual element is activated, a start-triggering signal is generated and transmitted to the virtual conferencing platform 102 for starting an interactive session with a corresponding combination of interaction options. For example, the interactive session is a poll session initiated by a host during the virtual conference, the interaction topic is a poll question, the combination of interaction options is a combination of answer options for the poll question, and the multiple responses are selections from the combination of answer options by participants. A mapping between multiple triggering components and multiple combinations of answer options can be stored on the virtual conferencing platform 102. The host UI can display the multiple combinations of answer options mapped to corresponding buttons on the UI. The host UI can also display the multiple combinations of answer options mapped to key combinations as a reference for the host. A key combination being pressed or a button on the UI being activated triggers the interactive component generation module 104 to generate a poll pod with the combination of answer options corresponding to the key combination or the button.

At block 206, the virtual conferencing platform 102 generates an interactive component 112 for the interactive session in response to receiving the start-triggering signal. The interactive component 112 includes a UI element presenting the combination of interaction options. In some examples, the interactive component generation module 104 on the virtual conferencing platform 102 transmits the corresponding combination of interaction options to the host device upon receiving the start-triggering signal. The host device may customize the corresponding combination of interaction options based on the interaction topic for the interactive session.

The interaction topic is usually included in the audio signal received from the host device 124 around the time the start-triggering signal is received from the host device 124. In some examples, a speech recognition module 106 can convert the audio signal from the host device to text substantially contemporaneous to receipt of the audio signal. An analysis module 108 of the virtual conferencing platform 102 can determine the interaction topic by analyzing the text around the time the start-triggering signal is received in real time or near real time. As an example, but not for limitation, the interaction topic is usually included in the audio signal during a period from one minute before receiving the start-triggering signal to one minute after receiving the start-triggering signal. The interaction topic can be presented in the UI element with the customized combination of interaction options.

Alternatively, or additionally, the analysis module 108 of the virtual conferencing platform 102 can implement a trained artificial intelligence (AI) algorithm to generate suggested interaction options based on the interaction topic extracted. An AI algorithm can be trained with training data including interaction topics and corresponding interaction options. The AI-generated interaction options can be presented on the host UI for editing or approving before the interactive component generation module 104 generates a UI element presenting the AI-generated interaction options and the extracted interaction topics. Functions included in block 204 can be used to implement a step for generating an interactive component for an interactive session during the virtual conference based on a combination of interaction options.

In some examples, the interactive session is a poll session, and the interactive component 112 generated by the interactive component generation module 104 is a poll pod. The poll pod includes a UI element presenting answer options for the poll question. As described above, the poll question can be extracted from the host speech around the time a start-triggering key is being pressed or a start-triggering button is being activated. It is optional to include the poll question on the UI element because the participants have received the poll question via audio. Alternatively, or additionally, the answer options can be generated by a trained AI algorithm using the extracted poll question.

At block 208, the virtual conferencing platform 102 causes the UI element presenting the combination of interaction options to be displayed in respective UIs of the virtual conference on the multiple participant devices 126. In some examples, the UI element is a modal window or popup window over the participant UI of the virtual conference. The UI element can include interactive elements. In some examples, the interactive elements are radio buttons or checkboxes corresponding to interaction options presented on the UI element. In some examples, the interactive elements are sliding bars or blank fields corresponding to interaction options displayed on the UI element. The interactive component generation module 104 can automatically select interactive elements for the UI element based on the attributes of the combination of interaction options. For example, when the interaction options are multiple choices, the interactive elements are radio buttons or checkboxes. As another example, when the interaction options are numerical inputs or free-form answers, the interactive elements are sliding bars or blank fields. In some examples, the virtual conferencing platform 102 or another device generates the UI element and transmits it to the respective participant devices for display. In other examples, the virtual conferencing platform 102 instructs the respective participant devices to generate the UI element for display. The interactive component generation module 104 can also add an interactive element (e.g., a button on a toolbar) in participant UIs when the UI element for the interactive component is generated. Toggling the interactive element can open or close the UI element presenting the combination of interaction options for the interactive session. In some examples, the interactive component is a poll pod for a poll session, and a floating window for the poll session is displayed in the participant UIs. The floating window includes answer options for a poll question corresponding to radio buttons or blank fields for interaction with participants. The participant UIs also includes a poll button which can be toggled for displaying or hiding the floating window.

At block 210, the virtual conferencing platform 102 receives multiple responses from the multiple participant devices 126. The multiple responses are based on the combination of interaction options. The virtual conferencing platform 102 is enabled to receive multimodal responses. That is, the responses can be from different input channels. The multiple responses can be received via different input devices on the multiple participant devices, such as keyboards, mouses, touchscreens, cameras, microphones, and transmitted to the virtual conferencing platform 102. For example, a participant can utter the response over a microphone connected to the participant device. The response can be captured without being transmitted to speaker devices connected to other participant devices or even the host device, using client-side speaker-independent isolated word recognition technology. As another example, a participant can display the response (e.g., holding a piece of paper including the response) over a camera connected to the participant device. The response can be captured without being displayed on the participant UIs or even the host UI, using client-side image recognition technology. The responses can be from input devices available for participants on site in a hybrid virtual conference, such as a handheld device preprogrammed to transmit responses to the virtual conference platform or input devices on participant devices installed with a client-side application for the hybrid virtual conference. In some examples, once a participant device transmits a response to the virtual conferencing platform 102, the participant device cannot transmit another response during the interactive session. In some examples, a participant device can update its response as long as the interactive session is active. The most recent response overwrites previous responses and represents the response from the participant device. The responses can be anonymous. That is, the participant identity is not attached to the response. However, the virtual conferencing platform 102 may generate or record a unique identifier for responses from a particular participant device so that the virtual conferencing platform 102 can remove previously received responses from a participant device and store the most recent response only. For example, the unique identifier is the Internet Protocol (IP) address or a Media Access Control (MAC) address for a particular participant device. An analysis module 108 may analyze the responses and generate a distribution of the responses or an aggregated response. The interactive component generation module 104 can present the distribution or the aggregated response in the UI element with the combination of interaction options in the participant UIs. In some examples, the distribution or aggregated response is presented dynamically in real time or near real time on the UI element as more responses are received and processed during the interactive session. The distribution or the aggregated response can be presented as a percentage number for each interaction option. The distribution or the aggregated response can also be presented using a visual chart statistically representing different interaction options as responses. In some examples, the interactive session is a poll session with a poll question, participant devices can select certain answer options or type in responses to the poll question in a floating window. When more than one answer option is displayed in the floating window, a horizontal bar can be generated and displayed under each answer option representing a percentage of responses being the particular answer option. The horizontal bars can be displayed when the interactive session is ended. The horizontal bars can also be dynamically displayed while responses are being received.

At block 212, the virtual conferencing platform 102 receives an end-triggering signal for ending the interactive session from the host device 124. Similar to the mapping data associated with the start-triggering signal, mapping data stored in the data store 114 includes a mapping between an end-triggering component and a command of ending the interactive session. In some examples, the end-triggering component is a key (e.g., key E) on the keyboard preset to be associated with the command of ending the interaction session. When the key on the host device is being pressed or otherwise activated, an end-triggering signal is generated and transmitted to the interactive component generation module 104, which can translate the end-triggering signal into a command of ending the interactive session. In some examples, the end-triggering component is a graphic element on a host UI of the virtual conference. The host UI may present “end the interactive session” next to the graphic element. The graphic element can be a button or a checkbox. When the graphic element is activated, an end-triggering signal is generated and transmitted to the interactive component generation module 104, which then translates the end-triggering signal into a command of ending the interactive session. In some examples, the interactive session is a poll session, and a key is preprogrammed to a command of ending the poll session. An instruction such as “press E to end the poll” can be displayed in the host UI as a guide. Alternatively, a button associated with text “end the poll” can be included in the host UI. Pressing or clicking the button can generate a signal to end the poll session. When the key or the button is being pressed, the interactive session is ended.

At block 214, the virtual conferencing platform 102 deactivates the interactive component 112 on the multiple participant devices 126 in response to receiving the end-triggering signal. Upon receiving the end-triggering signal, the interactive component generation module 104 can execute the corresponding command of ending the interactive session by deactivating the interactive component on the multiple participant devices 126. Functions included in block 212 and block 214 can be used to implement a step for deactivating the interactive component on the plurality of participant devices. In some examples, the interactive session is a poll session, and the interactive component is a poll pod. The poll pod can be deactivated by a hot key or a button on the host UI being pressed. The floating window presenting the answer options may disappear, or the interactive buttons in the floating window can be deactivated.

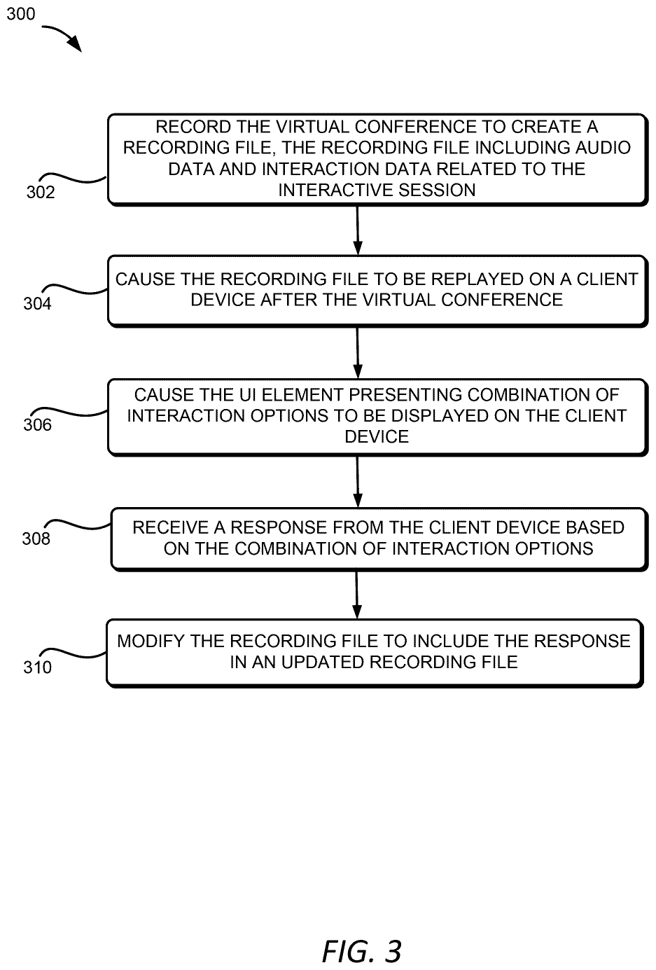

Now turning to FIG. 3, FIG. 3 depicts an example of a process 300 for recording and replaying the interactive session after the virtual conference is ended, according to certain embodiments of the present disclosure. At block 302, the virtual conferencing platform 102 records the virtual conference to create a recording file 118. The host UI may include a button for recording. When the recording button is activated, the recording module 110 of the virtual conferencing platform 102 can record the virtual conference including the interactive session and create a recording file 118. The recording file 118 is stored in the data store 114 of the virtual conferencing platform 102. The recording file 118 can include audio data for the virtual conference and interaction-related data for the interactive session. The interaction-related data can include a start timestamp for the receipt of the start-triggering signal and an end timestamp for the receipt of the end-triggering signal. The interaction-related data also includes interactive component 112 generated during the virtual conference, which includes the UI element presenting the combination of interaction options for the interactive session. The interaction-related data also includes the responses received from the multiple participant devices 126 during the interactive session.

If the interaction topic is not extracted and displayed on the UI element during the interactive session, the analysis module 108 of the virtual conferencing platform 102 can extract the interaction topic after the virtual conference, by processing the audio data in the recording file 118 around the start timestamp. A machine learning algorithm, such as a natural language processing algorithm, can be implemented to extract the interaction topic. The interaction topic can usually be detected within a time window around the start timestamp, such as between one minute before the start timestamp and one minute after the start timestamp. The interaction topic can be stored as part of the interaction-related data in the recording file. When the recording file 118 is being replayed via the virtual conferencing platform 102, the interaction component generation module 104 can modify the UI element to include the interaction topic for the interactive component.

At block 304, the virtual conferencing platform 102 causes the recording file to be replayed on a client device after the virtual conference. The client device can be another participant device associated with a user who missed the live virtual conference and tries to catch up by reviewing the replay of the recording file 118. The client device may request the host device for access to the recording file 118 stored in the data store 114 of the virtual conferencing platform 102. Once the client device is granted access to the recording file 118, the virtual conferencing platform 102 can stream the recording file 118 on the client device.

At block 306, the virtual conferencing platform 102 causes the UI element presenting the combination of interaction options to be displayed on the client device. The interactive component 112 for the interactive session can be reactivated for the client device during the replay of the recording file 118 for the virtual conference. The UI element presenting the combination of interaction options can be displayed on the UI replaying the virtual conference on the client device. The UI element can include interactive elements corresponding to the combination of interaction options for the interaction session. The interactive elements, such as radio buttons, checkboxes, sliding bars, and blank fields, are also activated for interaction with the client device. The UI element can also include the interaction topic.

At block 308, the virtual conferencing platform 102 receives a response from the client device based on the combination of interaction options. Similar to the multiple responses during the interactive session at block 210, the response from the client device can be received during the replay via an input device on the client device and transmitted to the virtual conferencing platform 102. The input device can be a keyboard, a mouse, a touchscreen, a camera, or a microphone.

At block 310, the virtual conferencing platform 102 modifies the recording file to include the response in an updated recording file. When the virtual conferencing platform 102 receives the response during the replay of the virtual conference, the virtual conferencing platform 102 can store the response as part of the interaction-related data and update the recording file 118. Additionally, the virtual conferencing platform 102 can transmit a message to the host device 124 notifying the receipt of the response. Meanwhile, the analysis module 108 can generate an updated report for the interactive session and send to the host device 124.

In some examples, the interactive session during the virtual conference is a poll session. The recording file for the virtual conference includes audio data for the virtual conference and poll data related to the poll session. The poll data can include a start timestamp for the receipt of the start-triggering signal indicating the start of the poll and an end timestamp for the receipt of the end-triggering signal indicating the end of the poll. The poll data also includes the poll pod generated during the virtual conference, which includes a floating window presenting the answer options for a poll question. The poll data also includes the responses received from the multiple participant devices during the poll session. When the recording file stored on the virtual conferencing platform is replayed on a new participant device, the poll pod is reactivated. The floating window presenting the answer options for the poll question is also reactivated with any interactive buttons in the floating window. The new participant can interact with the floating window by selecting an answer option or typing in an answer. The virtual conferencing platform can store the selected answer option or typed-in answer and update the poll data in the recording file. The recording file is thus updated as well.

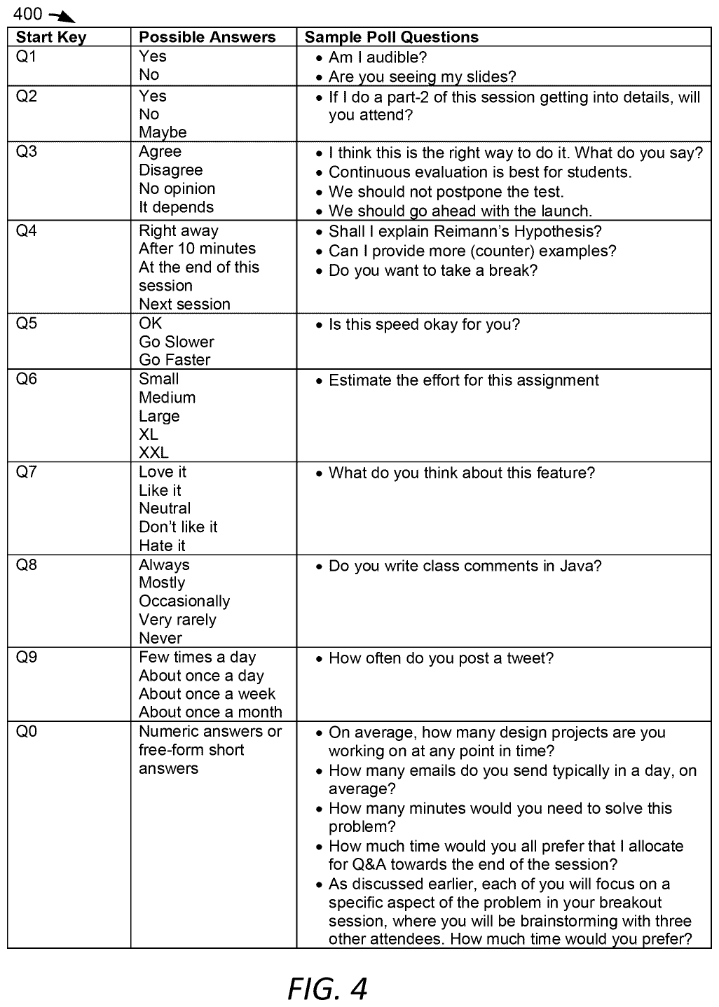

Now turning to FIG. 4, FIG. 4 depicts a mapping 400 between start keys and possible answers to corresponding sample poll questions, according to certain embodiments of the present disclosure. For example, the letter Q key and the number 1 key can be a key combination associated with a group of possible answers “Yes” and “No” for certain poll question, such as “Am I audible?” or “Are you seeing my slides?” When the key combination Q1 is being pressed down together, a start-triggering signal is transmitted to the virtual conferencing platform 102 indicating a start of a poll session. The group of possible answers “Yes” and “No” associated with the Q1 combination can be transmitted to a poll generator (not shown), such as the interactive component generation module 104 on the virtual conferencing platform 102, for generating a poll pod for the poll session. The interactive component generation module 104 can transmit the group of possible answers to the host UI for customization. When the host device approves the group of possible answers, the interactive component generation module 104 can generate a UI element, such as a floating window, presenting the group of possible answers with corresponding interactive elements, such as radio buttons and checkboxes, and send the UI element to participant UIs for display on participant devices. Similarly, start key combinations Q2, Q3, Q4, Q5, Q6, Q7, Q8, and Q9 are mapped to other groups of possible answers to corresponding sample poll questions, as shown in FIG. 4. In addition to multiple choice answers illustrated by different groups of possible answers mapped to Q1-Q9, numeric answers or free-form short answers can be enabled. For example, the key combination Q0 is mapped to numeric answers or free-form short answers. The interactive component generation module 104 can generate a UI element including interactive elements, such as sliding bars or blank fields, requesting for numeric answer or free-form short answers. The mapping 400 can be stored as mapping data 116 in the data store 114 of the virtual conferencing platform 102. The mapping 400 can be updated by the virtual conferencing platform 102, for example, by adding new start key combinations and new groups of possible answers and by editing existing start key combinations or groups of possible answers. The mapping 400 can also be presented on the host UI of a virtual conference.

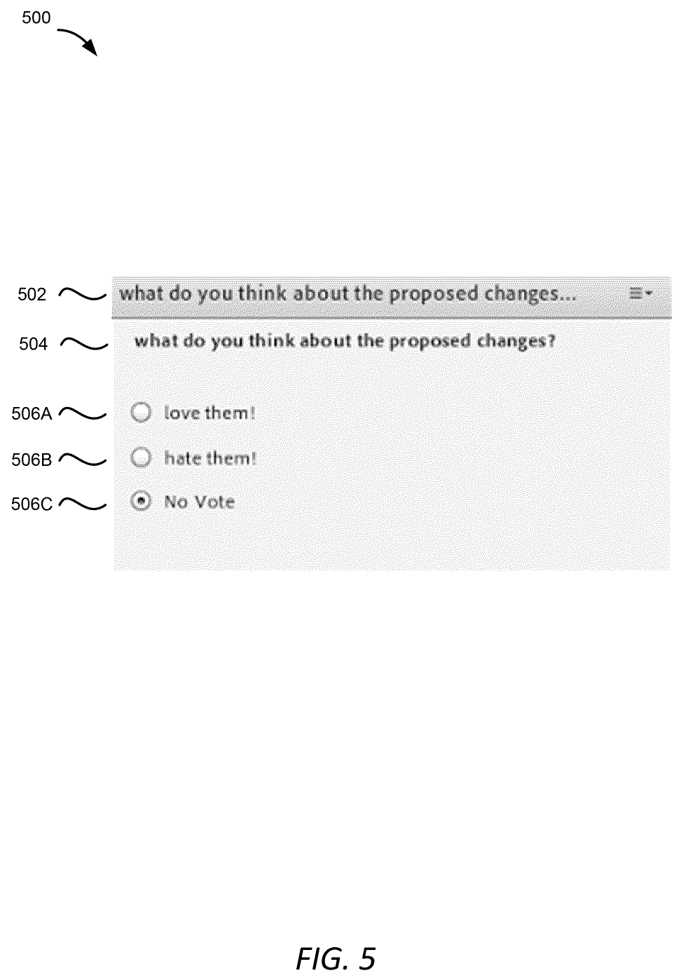

FIG. 5 depicts an example of a floating window 500 presenting a poll question and a group of possible answers, according to certain embodiments of the present disclosure. The floating window 500 can be displayed in participant UIs of a virtual conference on participant devices 126. The subject 502 of the floating window can be presented at the top of the floating window. Here, the subject 500 of the floating window is the poll question. The poll question 504 is also presented with a group of possible answers 506A, 506B, and 506C in the main body of the floating window 500. The group of possible answers 506A-506C are associated with radio buttons. A radio button can be activated via mouse or touchscreen to generate a response to the poll question 504 from a participant device, the response being a possible answer 506A, 506B, or 506C.

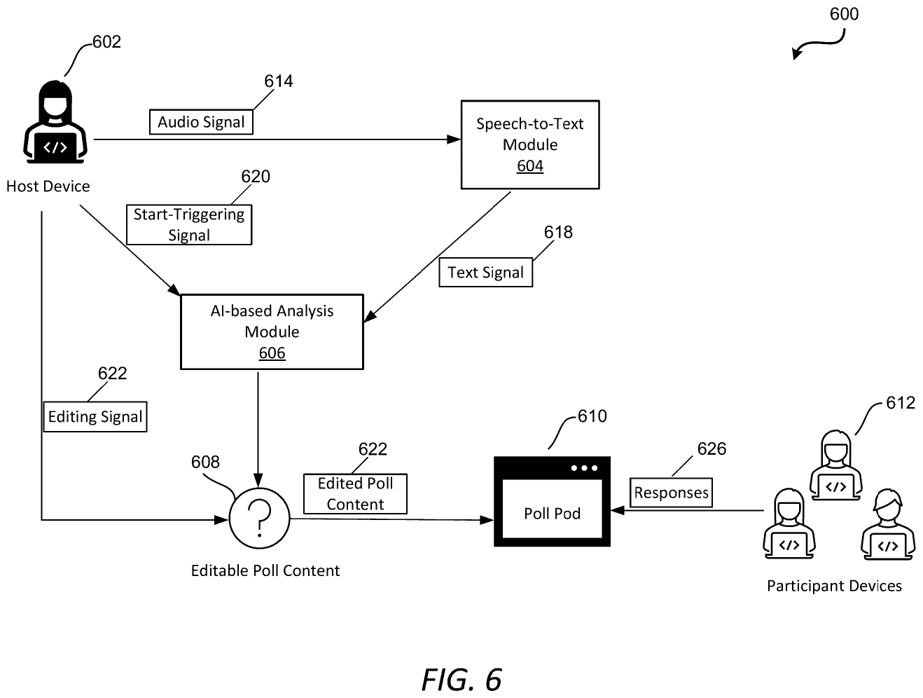

FIG. 6 depicts an example workflow 600 of creating a poll pod during a virtual conference, according to certain embodiments of the present disclosure. During a virtual conference, a host device 602 of the virtual conference, transmits an audio signal 614 to a speech-to-text module 604 on a virtual conferencing platform. A host's speech can be captured by a microphone to create the audio signal 614. The speech-to-text module 604 can convert the audio signal 614 to a text signal 618 and transmit the text signal 618 to an AI-based analysis module 606. Meanwhile, the host device 602 can transmit a start-triggering signal 620 to the AI-based analysis module 606. The start-triggering signal 620 is generated by activating a hotkey on the host device 602 or a visual element on the host UI, indicating a start of a poll session. In some examples, the hotkey or the visual element is associated with a group of possible answers stored on the virtual conferencing platform. When the start-triggering signal 620 is transmitted, the group of possible answers is also transmitted to the AI-based analysis module 606. The AI-based analysis module 606 can implement a natural language processing algorithm for processing the text signal 618 to extract a poll question around the time when the start-triggering signal 620 is received. In some examples, the AI-based analysis module 606 can also implement a machine learning algorithm for generating a group of possible answers based on the extracted poll question. The extract poll question and the group of possible answers either stored on the virtual conferencing platform or generated by the AI-based analysis module 606, collectively as editable poll content 608, can be transmitted to the host device 602 for editing. The host device 602 may generate an editing signal 622 to edit the editable poll content 608. The edited poll content 624 is used to generate a poll pod 610. The poll pod 610 includes a poll window presenting the poll question and corresponding possible answers. The poll pod 610 is accessible via participant UIs of the virtual conference on participant devices 612. The participant devices 612 can transmit their responses 626 to the poll pod 610.

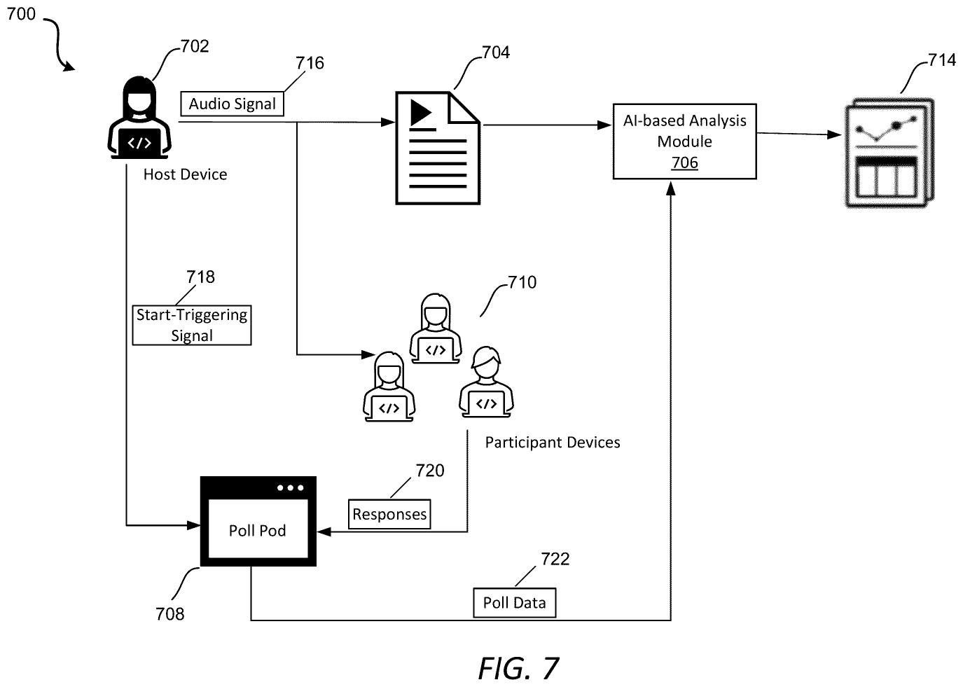

FIG. 7 depicts an example workflow 700 of creating a report for a poll session after a virtual conference, according to certain embodiments of the present disclosure. A host device 702 during a virtual conference can transmit an audio signal 716 for the host speech to participant devices 710. The audio signal 716 can be recorded into a recording file 704. The audio signal 716 includes a poll question. To start an interactive session, the host device 702 can transmit a start-triggering signal 718 to a poll generator (not shown), such as an interactive component generation module 104 on a virtual conferencing platform, to generate a poll pod 708. The start-triggering signal 718 can be generated by an activation of a hotkey or a visual element on the host UI. The hotkey or the visual element is associated with a particular group of possible answers stored on the virtual conferencing platform 102. When the start-triggering signal 718 is transmitted to the poll generator, the group of possible answers is also obtained by the poll generator for generating the poll pod 708. The poll pod 708 includes a poll window presenting the group of possible answers to the poll question. The poll window of the poll pod 708 can be displayed in participant UIs on the participant devices 710 for interaction. The participant devices 710 can transmit responses 720 to the poll pod 708. In this example, the poll question is not presented in the poll window during the poll session. The participants devices 710 receive the poll question from the audio signal 716 captured by the participant devices 710. However, since the audio signal 716 from the host device 702 is recorded in a recording file 704, the recording file 704 can be processed by an AI-based analysis module 706 to convert the audio data in the recording file 704 to text. The AI-based analysis module 706 can analyze the text and extract the poll question. The AI-based analysis module 706 can also analyze the poll question extracted and the poll data 722 collected from the poll pod 708, such as the group of possible answers and responses 720, to create a report 714 for the poll session.

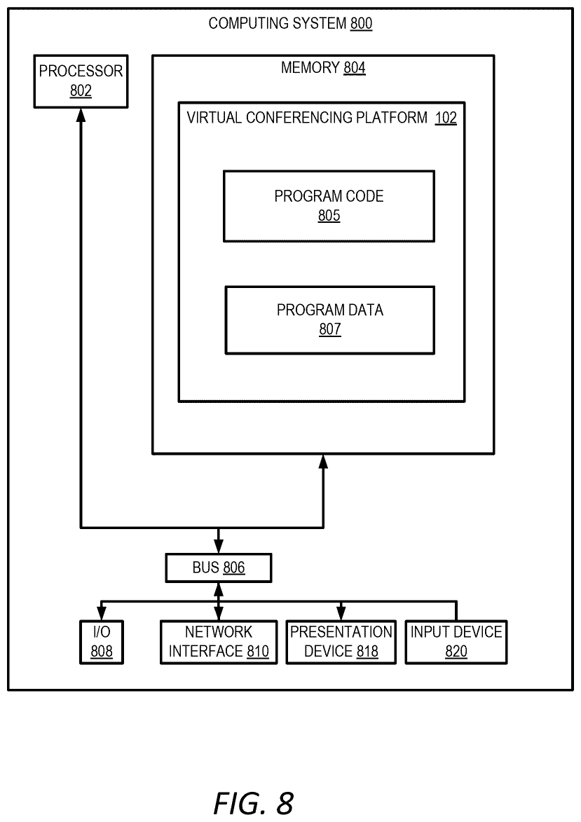

Any suitable computing system or group of computing systems can be used for performing the operations described herein. For example, FIG. 8 depicts an example of the computing system 800 for implementing certain embodiments of the present disclosure. The implementation of computing system 800 could be used to implement the virtual conferencing platform 102. In other embodiments, a single computing system 800 having devices similar to those depicted in FIG. 8 (e.g., a processor, a memory, etc.) combines the one or more operations depicted as separate systems in FIG. 1.

The depicted example of a computing system 800 includes a processor 802 communicatively coupled to one or more memory devices 804. The processor 802 executes computer-executable program code stored in a memory device 804, accesses information stored in the memory device 804, or both. Examples of the processor 802 include a microprocessor, an application-specific integrated circuit (“ASIC”), a field-programmable gate array (“FPGA”), or any other suitable processing device. The processor 802 can include any number of processing devices, including a single processing device.

A memory device 804 includes any suitable non-transitory computer-readable medium for storing program code 805, program data 807, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C #, Visual Basic, Java, Python, Perl, JavaScript, and ActionScript.

The computing system 800 executes program code 805 that configures the processor 802 to perform one or more of the operations described herein. Examples of the program code 805 include, in various embodiments, the application executed by the interactive component generation module 104 for generating an interactive component 112 during a virtual conference, or other suitable applications that perform one or more operations described herein. The program code may be resident in the memory device 804 or any suitable computer-readable medium and may be executed by the processor 802 or any other suitable processor.

In some embodiments, one or more memory devices 804 stores program data 807 that includes one or more datasets and models described herein. Examples of these datasets include extracted images, feature vectors, aesthetic scores, processed object images, etc. In some embodiments, one or more of data sets, models, and functions are stored in the same memory device (e.g., one of the memory devices 804). In additional or alternative embodiments, one or more of the programs, data sets, models, and functions described herein are stored in different memory devices 804 accessible via a data network. One or more buses 806 are also included in the computing system 800. The buses 806 communicatively couples one or more components of a respective one of the computing system 800.

In some embodiments, the computing system 800 also includes a network interface device 810. The network interface device 810 includes any device or group of devices suitable for establishing a wired or wireless data connection to one or more data networks. Non-limiting examples of the network interface device 810 include an Ethernet network adapter, a modem, and/or the like. The computing system 800 is able to communicate with one or more other computing devices (e.g., a host device 124 or participant devices 126) via a data network using the network interface device 810.

The computing system 800 may also include a number of external or internal devices, an input device 820, a presentation device 818, or other input or output devices. For example, the computing system 800 is shown with one or more input/output (“I/O”) interfaces 808. An I/O interface 808 can receive input from input devices or provide output to output devices. An input device 820 can include any device or group of devices suitable for receiving visual, auditory, or other suitable input that controls or affects the operations of the processor 802. Non-limiting examples of the input device 820 include a touchscreen, a mouse, a keyboard, a microphone, a separate mobile computing device, etc. A presentation device 818 can include any device or group of devices suitable for providing visual, auditory, or other suitable sensory output. Non-limiting examples of the presentation device 818 include a touchscreen, a monitor, a speaker, a separate mobile computing device, etc.

Although FIG. 8 depicts the input device 820 and the presentation device 818 as being local to the computing device that executes the virtual conferencing platform 102, other implementations are possible. For instance, in some embodiments, one or more of the input device 820 and the presentation device 818 can include a remote client-computing device that communicates with the computing system 800 via the network interface device 810 using one or more data networks described herein.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alternatives to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

That which is claimed is:

1. A method performed by one or more processing devices, comprising:
establishing a virtual conference among a host device and a plurality of participant devices;
receiving, during the virtual conference, a start-triggering signal from the host device to start an interactive session, the start-triggering signal being associated with a combination of interaction options, the interactive session being associated with an interaction topic, the combination of interaction options, and a plurality of responses;
in response to receiving the start-triggering signal, generating an interactive component for the interactive session, the interactive component for the virtual conference comprising a user interface (UI) element presenting the combination of interaction options;
causing the UI element presenting the combination of interaction options to be displayed in respective participant UIs of the virtual conference on the plurality of participant devices;
receiving the plurality of responses from the plurality of participant devices, the plurality of responses being based on the combination of interaction options;
receiving an end-triggering signal for ending the interactive session from the host device; and
deactivating the interactive component on the plurality of participant devices in response to receiving the end-triggering signal.

2. The method of claim 1, wherein the start-triggering signal is generated based on detecting one or more keystrokes, wherein the one or more keystrokes are preset to be associated with the combination of interaction options.

3. The method of claim 1, wherein the start-triggering signal is generated based on a visual element in a host UI of the virtual conference on the host device being activated, wherein the visual element is preset to be associated with the combination of interaction options.

4. The method of claim 1, wherein the plurality of responses are inputs from one or more input devices on the plurality of participant devices, the one or more input devices comprising keyboard, mouse, touchscreen, camera, or microphone.

5. The method of claim 1, wherein the end-triggering signal is generated based on a preset hotkey being pressed.

6. The method of claim 1, wherein the end-triggering signal is generated based on a graphic element in a host UI of the virtual conference on the host device being activated, wherein the graphic element is preset to be associated with ending the interactive session.

7. The method of claim 1, further comprising:
converting an audio signal received from the host device to a text message;
determining the interaction topic for the interactive session from the text message during the interactive session; and
causing the interaction topic to be displayed in the UI element presenting the combination of interaction options in the respective participant UIs of the virtual conference on the plurality of participant devices.

8. The method of claim 7, wherein the audio signal is received during a period from a first time point before receiving the start-triggering signal to a second time point after receiving the start-triggering signal.

9. The method of claim 1, further comprising:
broadcasting an aggregated response of the plurality of responses to the plurality of participant devices.

10. The method of claim 1, further comprising:
recording the virtual conference to create a recording file for the virtual conference, wherein the recording file comprises audio data for the virtual conference and interaction-related data for the interactive session; and
inserting a first timestamp for receipt of the start-triggering signal in the recording file.

11. The method of claim 10, further comprising:
after the virtual conference, extracting a segment of audio data from the recording file, wherein the segment of audio data is from one minute before the first timestamp to one minute after the first timestamp;
converting the segment of audio data to a text;
determining the interaction topic of the interactive session from the text; and
creating a report using the interaction topic and the plurality of responses.

12. The method of claim 10, further comprising:
causing the recording file for the virtual conference to be replayed on a participant device;
causing the UI element presenting the combination of interaction options to be displayed on the participant device;
receiving a response from the participant device based on the combination of interaction options; and
modifying the recording file to include the response in an updated recording file.

13. The method of claim 1, wherein the interactive session is a poll session, wherein the combination of interaction options is a combination of answer options, and wherein the interaction topic is a poll question.

14. A system, comprising:
a memory component;
a processing device coupled to the memory component, the processing device to perform operations comprising:
establishing a virtual conference among a host device and a plurality of participant devices;
receiving, during the virtual conference, a start-triggering signal from the host device to start an interactive session, the start-triggering signal is associated with a combination of interaction options;
in response to receiving the start-triggering signal, generating an interactive component for the interactive session of the virtual conference, the interactive component comprising a UI element presenting the combination of interaction options;
causing the UI element presenting the combination of interaction options to be displayed in respective UIs of the virtual conference on the plurality of participant devices;
receiving a plurality of responses from the plurality of participant devices; and
deactivating the interactive component in the respective UIs of the virtual conference on the plurality of participant devices.

15. The system of claim 14, wherein the memory component is configured to store mapping data between multiple combinations of interaction options and multiple start-triggering components, wherein the multiple combinations of interaction options are displayed on a host UI of the virtual conference on the host device.

16. The system of claim 15, wherein the multiple start-triggering components are multiple combinations of hotkeys, wherein the start-triggering signal is generated based on a combination of hotkeys mapped to the combination of interaction options being pressed.

17. The system of claim 15, wherein the multiple start-triggering components are multiple graphic elements on the host UI of the virtual conference on the host device, wherein the start-triggering signal is generated based on a graphic element mapped to the combination of interaction options being activated.

18. A non-transitory computer-readable medium, storing executable instructions, which when executed by a processing device, cause the processing device to perform operations comprising:
establishing a virtual conference among a host device and a plurality of participant devices;
a step for automatically generating an interactive component for an interactive session during the virtual conference based on a combination of interaction options;
causing the combination of interaction options to be displayed in respective participant UIs of the virtual conference on the plurality of participant devices;
receiving a plurality of responses based on the combination of interaction options from the plurality of participant devices; and
a step for deactivating the interactive component on the plurality of participant devices.

19. The non-transitory computer-readable medium of claim 18, wherein the plurality of responses are inputs from one or more input devices on the plurality of participant devices comprising keyboard, mouse, touchscreen, camera, or microphone.

20. The non-transitory computer-readable medium of claim 18, wherein the operations further comprise:
recording the virtual conference to create a recording file for the virtual conference, wherein the recording file comprises audio data for the virtual conference and interaction-related data for the interactive session; and
causing the recording file for the virtual conference to be replayed on a participant device after the virtual conference;
causing the combination of interaction options to be displayed on the participant device;
receiving a response from the participant device based on the combination of interaction options; and
modifying the recording file to include the response in an updated recording file.
